(19) United States
(12) Patent Application Publication
(10) Pub. No.: US 2025/0347156 A1
(43) Pub. Date: Nov. 13, 2025

(54) VEHICLE CLOSURE LATCH WITH BIDIRECTIONAL RELEASE MOTOR CONFIGURATION

(71) Applicant: MAGNA CLOSURES INC., Newmarket (CA)

(72) Inventor: Francesco CUMBO, Newmarket (CA)

(21) Appl. No.: 19/206,187

(22) Filed: May 13, 2025

Related U.S. Application Data
(60) Provisional application No. 63/645,975, filed on May 13, 2024.

(51) Int. Cl. E05B 81/14; B60R 5/02; E05B 81/06; E05B 81/30; E05B 81/34; E05B 83/24; E05B 85/24

(52) U.S. Cl. CPC E05B 81/14; E05B 81/06; E05B 81/30; E05B 81/34; E05B 83/243; E05B 85/245; B60R 5/02

(57) ABSTRACT

A latch assembly for a motor vehicle including a ratchet assembly for retaining and releasing a striker, a pawl assembly for holding the ratchet assembly in one of a primary latched position and a secondary latched position, and for allowing the ratchet assembly to move to a fully unlatched position to release the striker, and a power release mechanism having a motor and a power release gear, where the motor is operable to rotate the power release gear in a first direction to move the pawl to allow the ratchet assembly to move from the primary latched position to the secondary latched position, and to rotate the power release gear in a second opposite direction to move the pawl to allow the ratchet assembly to move from the secondary latched position to the fully unlatched position.

### CROSS-REFERENCE TO RELATED APPLICATIONS

This application claims the benefit of U.S. Provisional Application Ser. No. 63/645,975, filed May 13, 2024, which is incorporated herein by reference in its entirety.

### FIELD

The present disclosure relates to generally to closure panels for motor vehicles, and more particularly, to power actuators for use with power-actuated mechanisms of closure panels.

### BACKGROUND

Motor vehicle closure panels, including various types of doors and various types of hoods, typically include power-actuated mechanisms, such as door presenters and latches with cinches, for example. Such power-actuated mechanisms are known to include features operable via selective actuation via one or more cables. The separate cables are typically actuated via separate dedicated actuators located remotely from one another. As such, space is needed for the separate actuators. Further, in some instances, coordinated movement of a pair cables configured in operable communication with separate ones of the actuators is needed to ensure desired and proper functioning of one or more of the power-actuated mechanisms and the features associated therewith. As such, a control mechanism must be configured in electrical communication with the separate actuators to ensure coordinated action thereof to ensure properly timed actuation of the power-actuated mechanisms and the features associated therewith. Accordingly, not only is valuable space occupied by the separate actuators, but also by the control mechanism and wires extending therefrom to the actuators.

While such power-actuated mechanisms having separate actuators can function satisfactorily for their intended purpose, drawbacks related to their packaging requirements, complexity of assembly and operation, and cost associated therewith exists.

In view of the above, there remains a need to develop alternative power-actuated mechanisms and actuators therefor which address and overcome packaging limitations associated with known power-actuated mechanisms and actuators, as well as to provide increased applicability while reducing cost and complexity.

### SUMMARY

This section provides a general summary of the present disclosure and is not a comprehensive disclosure of its full scope or all of its features, aspects and objectives.

In accordance with on aspect of the disclosure, a latch assembly for a motor vehicle includes a ratchet assembly having a primary striker capture position, whereat a striker is captured by the ratchet assembly and the latch assembly is in a primary latched state, a secondary striker capture position, whereat the striker is captured by the ratchet assembly and the latch assembly is in a secondary latched state, and a striker releasing position, whereat the striker is releasable from the ratchet assembly and the latch assembly is in a fully unlatched state. Latch assembly further includes a pawl for holding the ratchet assembly in one of the primary striker capture position and the secondary striker capture position, and for allowing the ratchet assembly to move to the striker releasing position. Latch assembly further includes a power release mechanism having a motor and a power release gear. The motor is operable to rotate the power release gear in a first direction to move the pawl in a first actuation to allow the ratchet assembly to move from the primary striker capture position to the secondary striker capture position, and to rotate the power release gear in a second direction, opposite the first direction, to move the pawl in a second actuation to allow the ratchet assembly to move from the secondary striker capture position to the striker releasing position.

In accordance with another aspect of the disclosure, the power release gear has a first feature configured to move the pawl while the power release gear is rotating in the first direction, and a second feature configured to move the pawl while the power release gear is rotating in the second direction.

In accordance with another aspect of the disclosure, the first feature is on a first face of the power release gear and the second feature is on a second face, opposite the first face, of the power release gear.

In accordance with another aspect of the disclosure, the first feature is configured to directly engage the pawl.

In accordance with another aspect of the disclosure, the second feature is configured to operably drive the pawl via a coupling lever.

In accordance with another aspect of the disclosure, the coupling lever has a first leg extending away from a pivot axis for selective engagement with the second feature, and a second leg extending away from the pivot axis for selective engagement with the pawl.

In accordance with another aspect of the disclosure, the coupling lever has a coupling lever rest position and coupling lever actuated position, wherein a coupling lever biasing member biases the coupling lever toward the coupling lever rest position.

In accordance with another aspect of the disclosure, the second feature does not engage the first leg during the first actuation, and wherein the second feature engages the first leg during the second actuation to move the coupling lever against the bias of the coupling lever biasing member from the coupling lever rest position to the coupling lever actuated position, whereupon the pawl is driven by the second leg from a pawl rest position to a ratchet releasing position, whereat the ratchet assembly is able move from the secondary striker capture position to the striker releasing position.

In accordance with another aspect of the disclosure, the second feature disengages the first leg upon completion of the second actuation to allow the coupling lever to return to the coupling lever rest position under the bias of the coupling lever biasing member, whereupon the pawl is returned under a bias of a pawl biasing member from the ratchet releasing position to the pawl rest position.

In accordance with another aspect of the disclosure, the pawl has a pawl rest position and a ratchet releasing position, the pawl being moved from the pawl rest position to the ratchet releasing position and back to the rest position during the first actuation, and the pawl being moved from the pawl rest position to the ratchet releasing position and back to the rest position during the second actuation.

In accordance with another aspect of the disclosure, the ratchet assembly includes primary ratchet having a primary striker slot and a secondary ratchet having a secondary striker slot, the primary ratchet supported for rotation about a primary ratchet axis and the secondary ratchet supported for rotation about a secondary ratchet axis spaced from the primary ratchet axis.

In accordance with another aspect of the disclosure, the primary ratchet captures the striker in the primary striker slot when the latch assembly is in the primary latched state, and the secondary ratchet captures the striker in the secondary striker slot when the latch assembly is in the secondary latched state.

In accordance with another aspect of the disclosure, the striker is released from the primary striker slot when the latch assembly is in the secondary latched state.

In accordance with another aspect of the disclosure, the primary striker slot and the secondary striker slot face each other.

In a related aspect, the latch assembly is adapted to releasably secure a closure panel of a frunk trunk to a motor vehicle body.

In accordance with another aspect of the disclosure, the power release mechanism employs a Geneva mechanism to allow release of the latch from the primary latched position to the secondary latched position by activating the motor in a first direction and to open from the secondary latched position to the full open position by powering the motor in an opposite second direction.

In accordance with on aspect of the disclosure, a latch assembly for a motor vehicle includes a ratchet assembly including a primary ratchet having a primary striker slot and a secondary ratchet having a secondary striker slot. The ratchet assembly has a primary striker capture position, whereat a striker is captured in the primary striker slot of the primary ratchet and the latch assembly is in a primary latched state, a secondary striker capture position, whereat the striker is captured in the secondary striker slot of the secondary ratchet and the latch assembly is in a secondary latched state, and a striker releasing position, whereat the striker is releasable from the secondary striker slot and the latch assembly is in a fully unlatched state. The latch assembly further includes a pawl for holding the primary ratchet in the primary striker capture position and for holding the secondary ratchet in the secondary striker capture position, and for allowing the ratchet assembly to move to the striker releasing position. The latch assembly further includes a power release mechanism having a motor and a power release gear. The motor is operable to rotate the power release gear in a first direction to move the pawl in a first actuation to allow the primary ratchet to move from the primary striker capture position to a primary striker releasing position, and to rotate the power release gear in a second direction, opposite the first direction, to move the pawl in a second actuation to allow the secondary ratchet to move from the secondary striker capture position to the secondary striker releasing position.

### BRIEF DESCRIPTION OF THE DRAWINGS

Other features, aspects and advantages of the present disclosure will be readily appreciated, as the same becomes better understood by reference to the following detailed description when considered in connection with the accompanying drawings wherein:

FIG. 1 is a side view of a vehicle including a latch assembly for a front trunk closure panel, in accordance with aspects of the present disclosure;

FIGS. 2A and 2B illustrate opposite side views of the latch assembly for the front trunk in a primary latched state;

FIGS. 3A and 3B illustrate opposite side views of the latch assembly for the front trunk showing a partial actuator travel in a first direction with a pawl being engaged by a release cam and partially actuated from a rest position toward a ratchet releasing position and the latch assembly being released from the primary latchet state to a secondary latched state;

FIGS. 4A and 4B illustrate opposite side views of the latch assembly for the front trunk showing a full actuator travel in the first direction with the pawl being fully actuated by the release cam in a first actuation to the ratchet releasing position and the latch assembly being released from the primary latchet state to the secondary latched state;

FIGS. 5A and 5B illustrate opposite side views of the latch assembly for the front trunk being released from the primary latchet state to the secondary latched state showing the full actuator travel and the pawl being biased back to the rest position by a pawl lever return spring;

FIGS. 6A and 6B illustrate opposite side views of the latch assembly for the front trunk showing a partial actuator travel in a second direction, opposite the first direction, with the pawl being reengaged by the release cam during an initial actuation from the rest position toward the ratchet releasing position and the latch assembly being initially released from the secondary latchet state to a fully unlatched state;

FIGS. 7A and 7B illustrate opposite side views of the latch assembly for the front trunk showing a continued, partial actuator travel in the second direction with a coupling lever being engaged by an actuator cam and with the release cam remaining in engagement with the pawl, with the pawl being moved toward the ratchet releasing position;

FIGS. 8A and 8B illustrate opposite side views of the latch assembly for the front trunk showing a view similar to FIGS. 7A and 7B and showing a snow load lever in an engaged position;

FIGS. 9A and 9B illustrate opposite side views of the latch assembly for the front trunk showing a continued, partial actuator travel in the second direction with the pawl bypassed by the release cam and with the release cam biased to a rest position and with the actuator cam remaining in engagement with the coupling lever;

FIGS. 10A and 10B illustrate opposite side views of the latch assembly for the front trunk showing a full actuator travel in the second direction with the coupling lever bypassed by the actuator cam and with the pawl lever biased back to the rest position by the pawl lever return spring, the coupling lever biased back to a rest position by a coupling lever return spring, and the snow load lever in a disengaged position; and

FIGS. 11A and 11B illustrate opposite side views of the latch assembly for the front trunk similar to FIGS. 10A and 10B with the latch assembly shown released from the secondary latched state to the fully unlatched state with the motor being in a rest position after being powered in a direction opposite the actuation direction of FIG. 3A and FIG. 3B.

### DETAILED DESCRIPTION OF EXAMPLE EMBODIMENTS

In general, example embodiments of power actuators having a dual cable actuating mechanism constructed in accordance with the teachings of the present disclosure and mechanically actuatable components operably coupled thereto for selective and independent mechanical actuation via cables of the dual cable actuating mechanism will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including.” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as inner,” “outer,” “beneath,” “below.” “lower,” “above,” “upper,” “top”, “bottom,” and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features.

Thus, the example term “below” can encompass both an orientation of above and below. The device may be otherwise oriented (rotated degrees or at other orientations) and the spatially relative descriptions used herein interpreted accordingly.

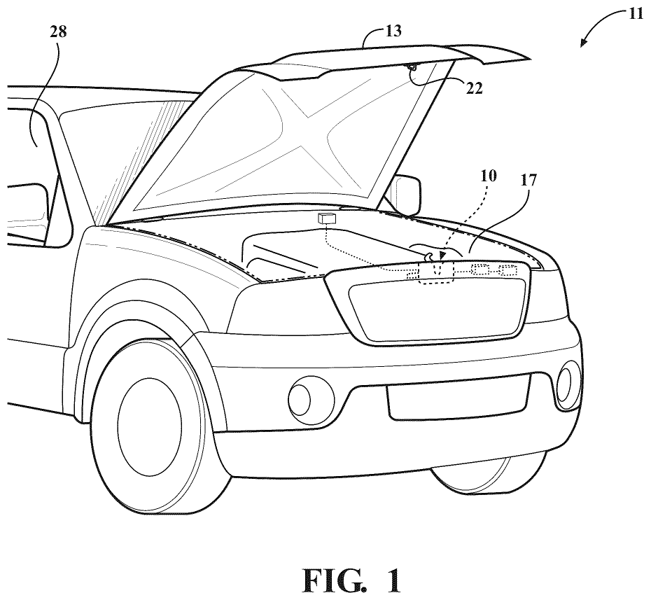

Reference is made to FIG. 1, which shows a motor vehicle 11 that has a closure panel, shown as a front hood 13, by way of example and without limitation, to which a striker 22 is fixedly attached. Front hood 13 may enclose an engine, in known fashion, or a front trunk 17, also referred to as frunk 17, for storage in a compartment provided in the front of the vehicle 11 where an engine typically would occupy but has been provided at another location in the vehicle. The striker 22 is capturable by a double pull closure panel latch assembly, also referred to as a double pull hood latch assembly if used in a vehicle hood application, and is generally referred to hereafter simply as double pull latch assembly or latch assembly 10, which is mounted on a body 15 of the motor vehicle 11.

The front hood 13, as permitted by latch assembly 10, can be moved from a fully closed position to various open positions, including a partially open position, whereat the front hood 13 is prevented from being fully opened absent further actuation of latch assembly 10, a released position, whereat the striker 22 of front hood 13 remains within latch assembly 10 but is readily removable therefrom without further actuation of latch assembly 10, and a fully open position, whereat front hood 13 is lifted and striker 22 is removed from latch assembly 10 (FIG. 1) to provide access to the stowage space, or frunk 17.

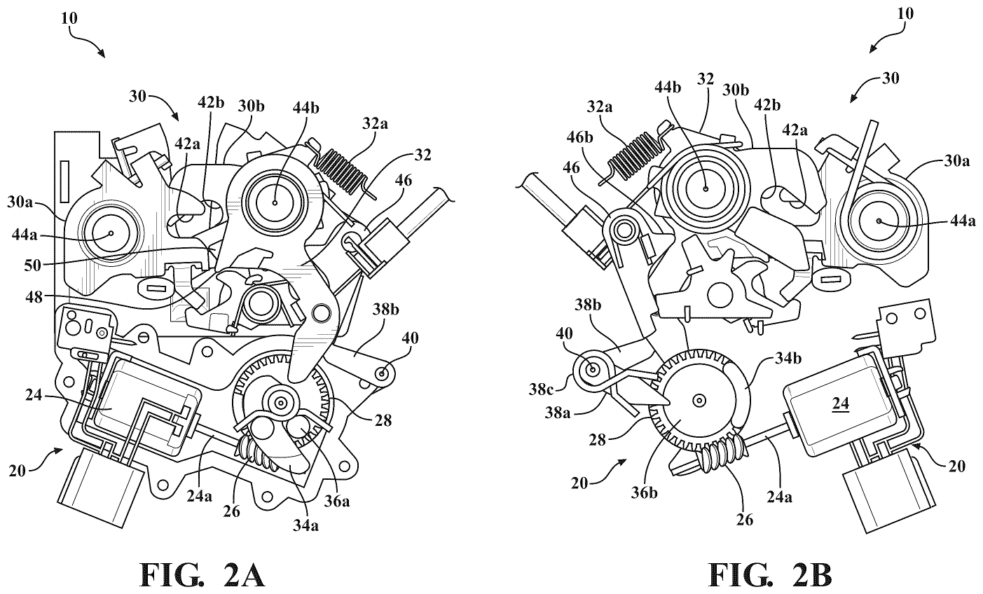

Latch assembly 10 is illustratively a double pull latch and may be constructed using components and configurations as shown and described in US Patent Publication No. US20220106817A1, the entire contents of which are incorporated herein by reference. In accordance with a presently preferred, non-limiting embodiment of the disclosure, components of latch assembly 10 are shown in FIGS. 2A and 2B, wherein the latch assembly 10 is illustrated in its fully closed state, also referred to as fully latched state.

Latch assembly 10 includes a power release mechanism 20 having an electric motor, referred to hereafter as motor 24, arranged to selective drive a motor shaft 24a and worm 26 fixed thereto in a first direction and an opposite second direction, as desired for the intended latch operation be performed. Worm 26 is arranged in meshed engagement with a power release gear 28, such that when worm 26 is driven in the first direction, power release gear 28 is driven in a first direction, and when worm 26 is driven in the second direction, power release gear 28 is driven in an opposite second direction.

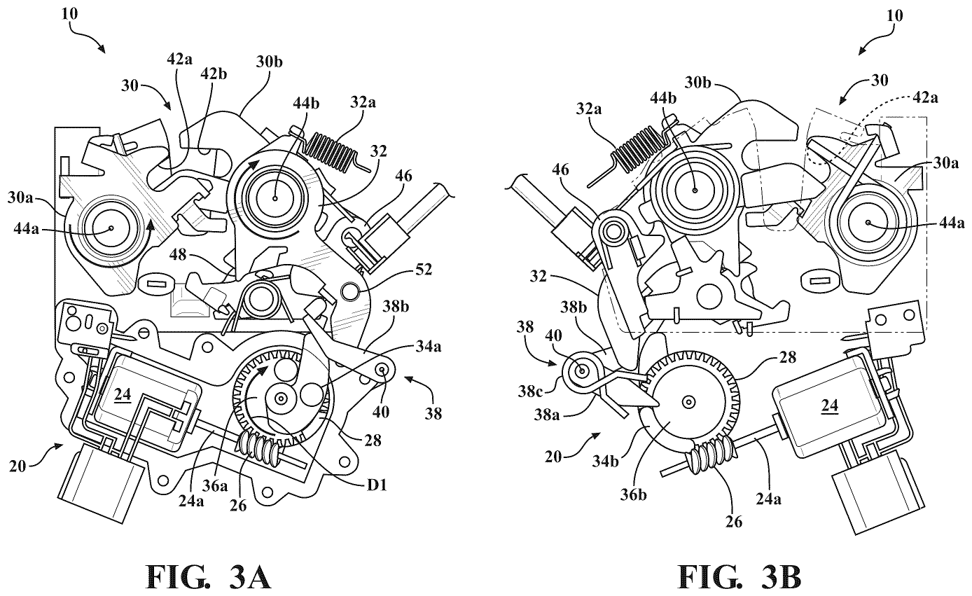

Latch assembly 10 includes a ratchet assembly 30 having a primary striker capture position (FIGS. 2A and 2B), whereat the striker 22 is captured by the ratchet assembly 30 and the latch assembly 10 is in a primary latched state, whereat the front hood 13 is in its fully closed position, a secondary striker capture position (FIGS. 3A-5B), whereat the striker 22 is captured by the ratchet assembly 30 and the latch assembly 10 is in a secondary latched state, whereat the front hood 13 is in its partially open position, and a striker releasing position, whereat the striker 22 is releasable from the ratchet assembly 30 and the latch assembly 10 is in a fully unlatched state, such that the front hood 13 can be moved to its fully open position. Latch assembly 10 also includes a pawl 32 for holding the ratchet assembly 30 in the primary striker capture position and the secondary striker capture position, at separate times, and for allowing the ratchet assembly 30 to move to the striker releasing position.

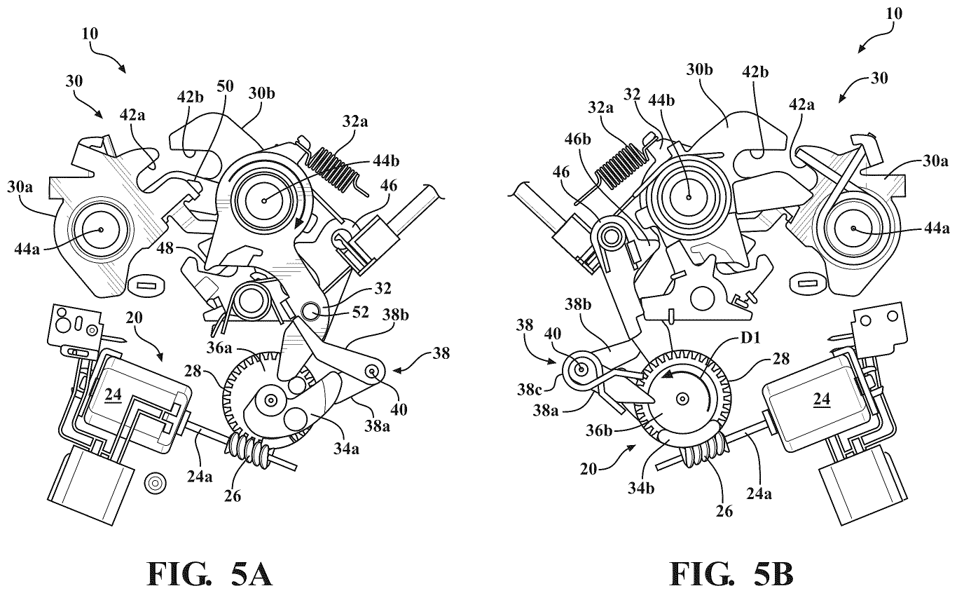

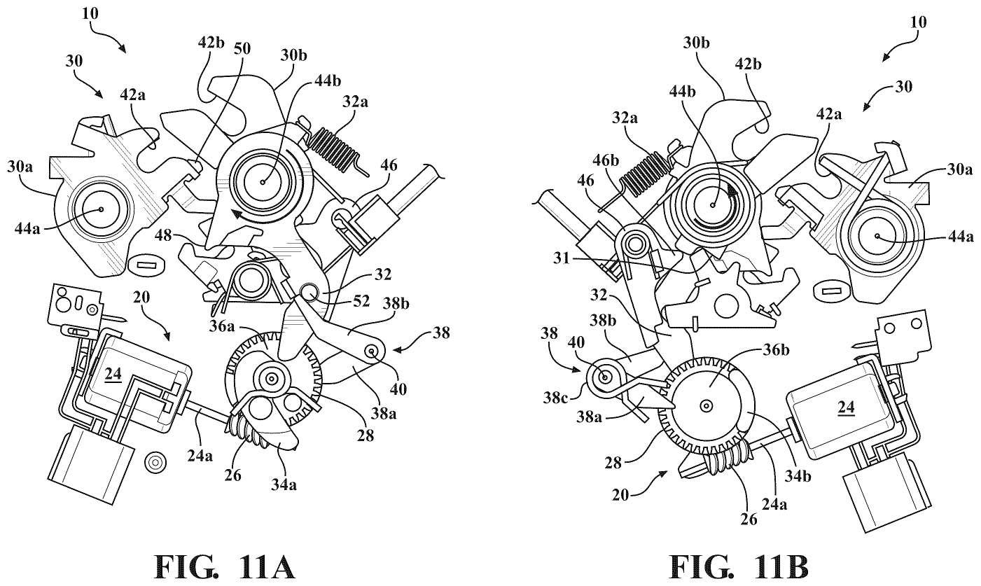

The motor 24, as indicated, is operable to rotate the power release gear 28 in a first direction D1 to move the pawl 32 in a first actuation to allow the ratchet assembly 30 to move from the primary striker capture position to the secondary striker capture position (FIGS. 5A and 5B), and to rotate the power release gear 28 in a second direction D2, opposite the first direction D1, to move the pawl 32 in a second actuation to allow the ratchet assembly 30 to move from the secondary striker capture position to the striker releasing position (FIGS. 11A and 11B).

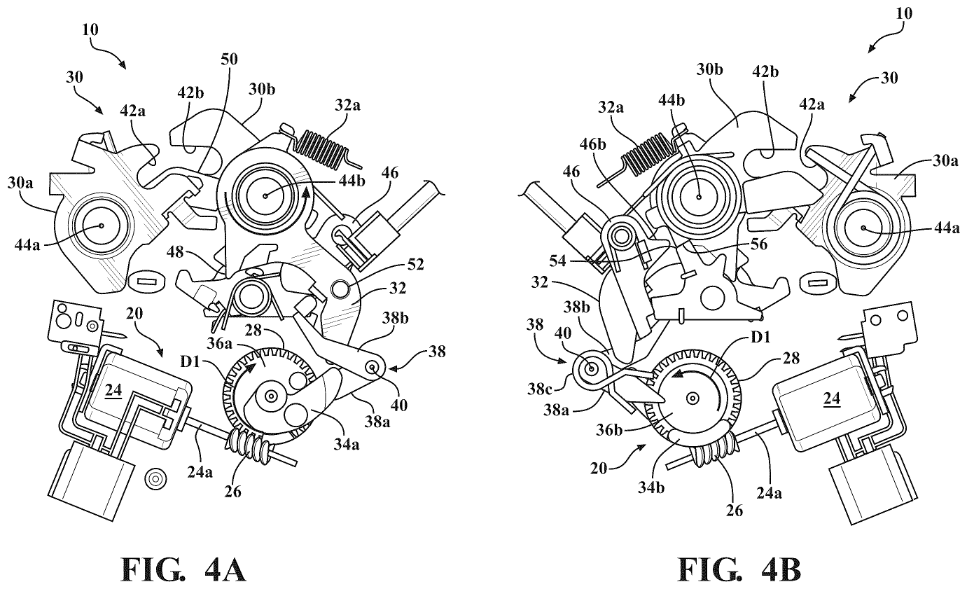

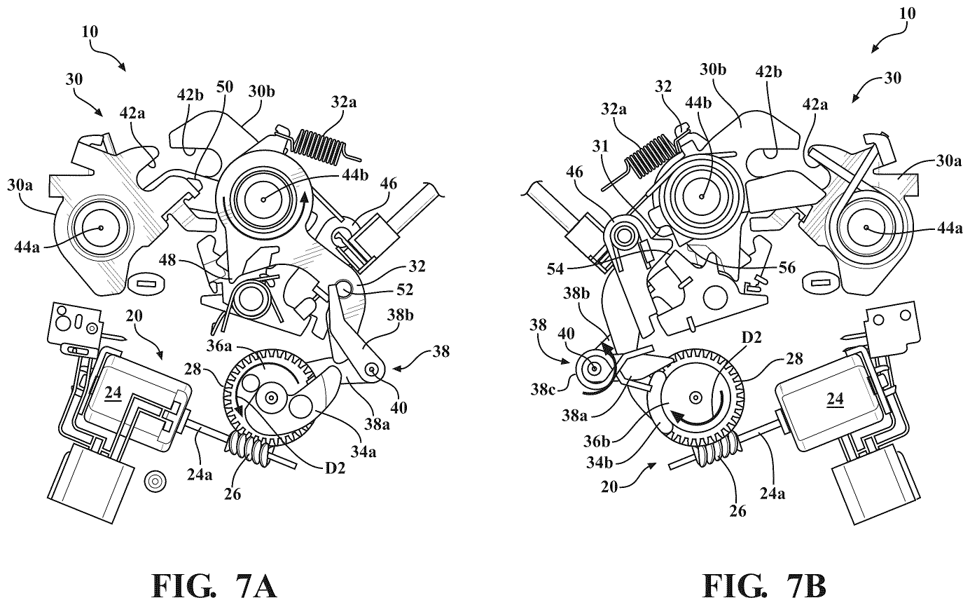

In operation, and with reference to FIG. 3A, the power release motor is controlled to rotate the power release gear 28 in a clockwise direction causing engagement of a first actuation feature, also referred to as first release cam or first feature 34a, provided on a first face 36a of the power release gear 28 to move the pawl 32 from a non-actuated, pawl rest position, also referred to as home position, to a ratchet releasing position, as shown in FIGS. 4A and 4B, and allow the ratchet assembly 30 to move from the primary striker capture position to the secondary striker capture position. After the pawl 32 has been actuated to the ratchet releasing position in a first actuation (e.g. a first pull), power release gear 28 is controlled by the motor 24 for continued rotation to bypass the pawl 32 (FIGS. 4A and 4B) to allow the pawl 32 to return to the pawl rest position, as shown in FIGS. 5A and 5B, such via a bias imparted by a pawl biasing member 32a. During the first actuation, the power release gear 28 rotates less than 360 degrees. A second actuation of the pawl 32 to release the latch assembly 10 from the secondary locked position occurs by powering the motor 24 to rotate in the opposite direction from the first actuation, causing an engagement of a second actuation feature, also referred to as second release cam or second feature 34b, on second face 36b of the power release gear (see FIG. 7B) to operably drive and move the pawl 32 a second time from the pawl rest position to the ratchet releasing position and allow the ratchet assembly 30 to move from the secondary striker capture position to the striker releasing position (FIG. 11A). Continued rotation of the motor 24 in the second direction returns the power release gear 28 to its home position. During the second actuation, the power release gear 28 rotates less than 360 degrees.

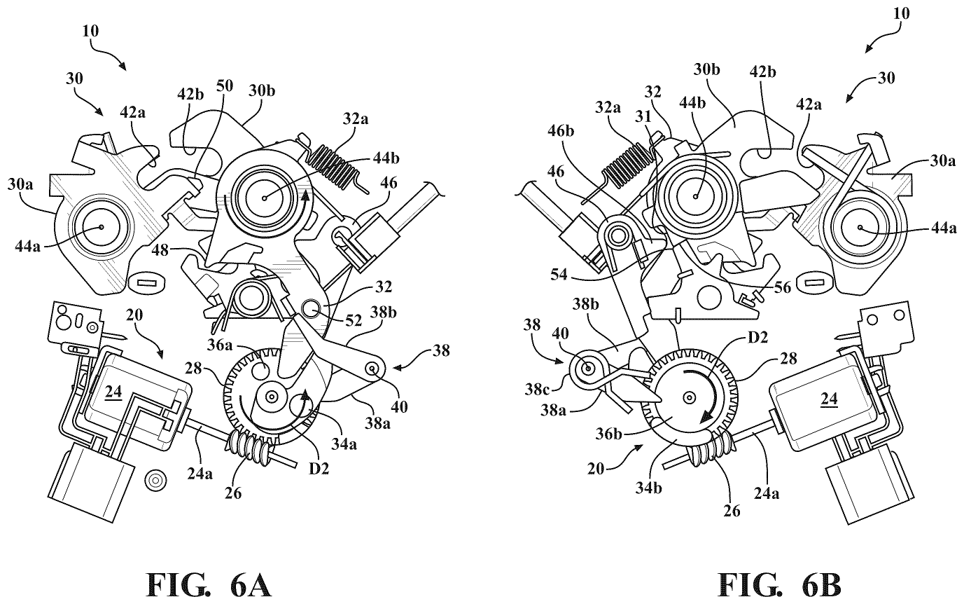

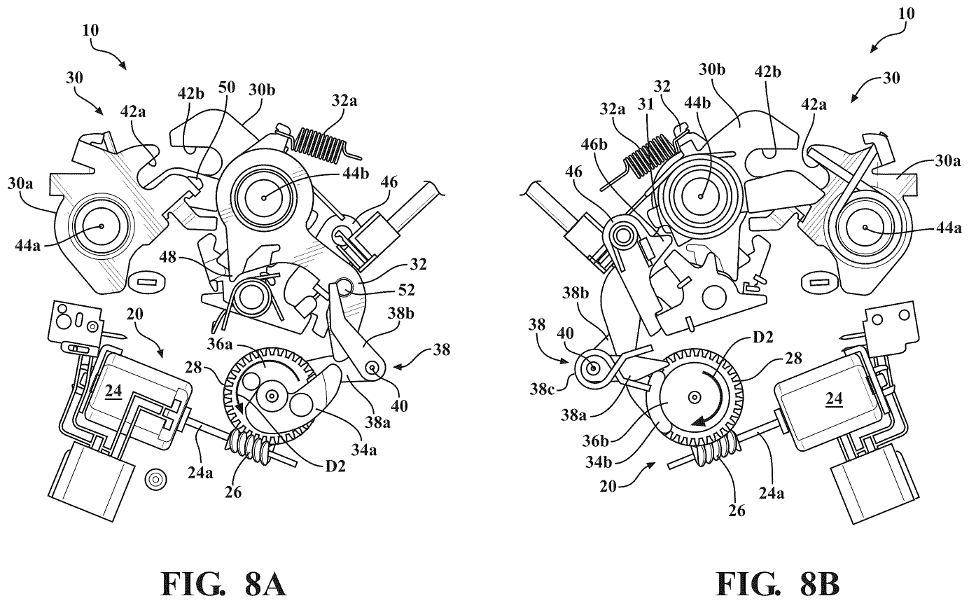

In accordance with further aspects, the second feature 34b is configured to operably drive the pawl 32 via a coupling lever 38. Coupling lever 38 has a first leg 38a extending away from a pivot axis 40 for selective engagement with the second feature 34b, and a second leg 38b extending away from the pivot axis 40 for selective engagement with the pawl 32. The first leg 38a and second leg 38b are shown extending in inclined relation from one another. The coupling lever 38 has a coupling lever rest position (FIGS. 6A and 6B) and a coupling lever actuated position (FIGS. 8A and 8B), wherein a coupling lever biasing member 38c biases the coupling lever 38 toward the coupling lever rest position.

In operation, the second feature 34b does not engage the first leg 38a during the first actuation of pawl 32, and wherein the second feature 34b engages the first leg 38a during the second actuation of pawl 32 to move the coupling lever 38 against the bias of the coupling lever biasing member 38c from the coupling lever rest position to the coupling lever actuated position, whereupon the pawl 32 is driven by the second leg 38b of coupling lever 38 from the pawl rest position to the ratchet releasing position, whereat the ratchet assembly 32 is able move from the secondary striker capture position to the striker releasing position. As motor 24 continues to rotate power release gear 28 in the second direction D2, the second feature 34b disengages the first leg 38a upon completion of the second actuation to allow the coupling lever 38 to return to the coupling lever rest position under the bias of the coupling lever biasing member 38c, whereupon the pawl 32 is returned under the bias of pawl biasing member 32a from the ratchet releasing position to the pawl rest position.

In accordance with further aspects, the ratchet assembly 30 includes primary ratchet 30a having a primary striker slot 42a and a secondary ratchet 30b having a secondary striker slot 42b. The primary striker slot 42a and the secondary striker slot 42b face each other. The primary ratchet 30a is supported for rotation about a primary ratchet axis 44a and the secondary ratchet 30b is supported for rotation about a secondary ratchet axis 44b spaced from the primary ratchet axis 44a. The primary ratchet 30a captures the striker 22 in the primary striker slot 42a when the latch assembly 10 is in the primary latched state, corresponding to the primary ratchet 30a being in a primary striker capture position, and the secondary ratchet 30b captures the striker 22 in the secondary striker slot 42b when the latch assembly 10 is in the secondary latched state, corresponding the secondary ratchet 30b being in a secondary striker capture position. The striker 22 is released from the primary striker slot 42a when the latch assembly 10 is in the secondary latched state, corresponding to the primary ratchet 30a being in a primary striker releasing position, and the striker 22 is releasable from the secondary striker slot 42b when the latch assembly 10 is in the unlatched state, corresponding to the secondary ratchet 30b being in a secondary striker releasing position.

In accordance with further aspects, a snow load lever 46 is provided having a blocking nose 46b to facilitate maintaining the front hood 13 in the partially open position while the latch assembly 10 is in a secondary latched state, whereat the secondary ratchet 30b is maintained in its secondary striker capture position via engagement of blocking nose 46b with a secondary lock surface 31 of secondary ratchet 30b to hold the striker 22 in the secondary striker capture position, such as when a load, e.g. snow, is on the front hood 13. The snow load lever 46, as best shown in FIG. 8B, facilitates movement of secondary ratchet 30b from the secondary striker capture position to the striker releasing position, whereat latch assembly 10 is in it unlatched state.

In operation, FIGS. 3A through 5B illustrate a first actuation of motor 24 and a first actuation of pawl 32 to cause the latch assembly 10 to move from the fully latched state to the secondary latched state. In FIG. 2A, pawl 32 is illustrated having a primary holding surface 48 engaged with a primary locking surface 50 of primary ratchet 30a. During the first actuation of motor 24, power release gear 28, as viewed in FIG. 3A, is driven clockwise in the first direction D1, wherein first actuation feature 34a, fixed to the first face 36a of power release gear 28, is rotated conjointly with power release gear 28 into driving engagement with pawl 32 (FIG. 3A) to rotate pawl 32 against the bias imparted by pawl biasing member 32a. As pawl 32 is rotated forcibly by first actuation feature 34a, primary holding surface 48 is moved out from engagement with primary locking surface 50 of primary ratchet 30a, whereupon primary ratchet 30a is permitted to move from its primary striker capture position to its primary striker releasing position, while secondary ratchet 30b moves to its secondary striker capture position. As motor 24 continues to drive power release gear 28 in the first direction D1, first actuation feature 34a bypasses an end of pawl 32, whereupon pawl 32 automatically returns to its pawl rest position under the bias imparted by pawl biasing member 32a (FIG. 5A), whereat latch assembly 10 is in its partially open state, and ratchet assembly 30 is in its secondary striker capture position, with secondary ratchet 30b being solely responsible for maintaining striker 22 in a captured state.

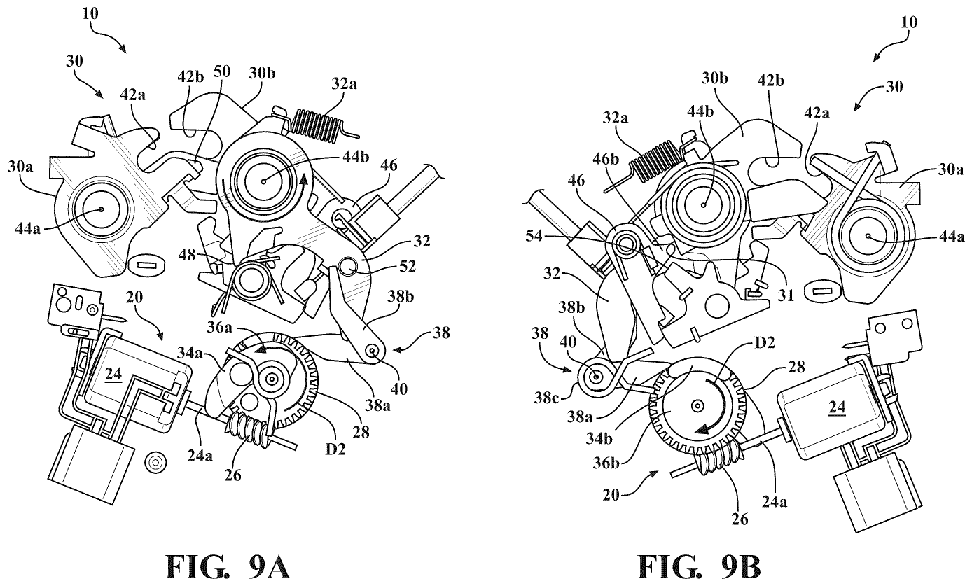

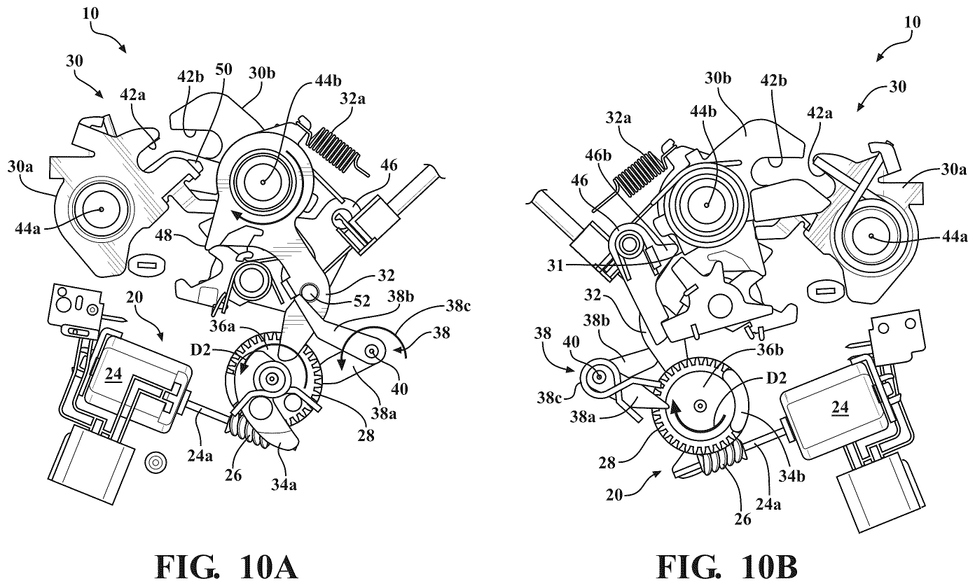

Then, to complete release of latch assembly 10 to its unlatched state, as shown in FIGS. 6A through 11B, a second actuation of motor 24 is performed to reverse the direction of rotation of motor shaft 24a and worm 26, thereby reversing the rotational direction of power release gear 28, as viewed in FIGS. 6A and 6B, such that power release gear 28 is now driven counterclockwise in the second direction D2. As such, second actuation feature 34b, fixed to the second face 36b of power release gear 28, is rotated conjointly with power release gear 28 toward and into driving engagement with the first leg 38a of coupling lever 38 (FIG. 7B) to cause coupling lever 38 to rotate about its pivot axis 40 against the bias imparted by coupling lever biasing member 38c. As coupling lever 38 continues to be rotated by movement of second feature 34b, the second leg 38b of coupling lever 38 is brought into driving engagement with pawl 32, and in particular, with a pawl lug 52 (FIG. 7B) extending in fixed relation from a generally planar body of pawl 32, whereupon pawl 32 is again caused to rotate in a second actuation against the bias imparted by pawl biasing member 32a to rotate an auxiliary pawl to move an auxiliary pawl holding surface 54a out from blocking engagement with a secondary locking surface 56 of secondary ratchet 30b (FIG. 7B). As pawl 32 drives auxiliary pawl rotatably, snow load lever 46 engages and holds auxiliary pawl to releasably maintain secondary holding surface 54 of auxiliary pawl out from engagement with secondary locking surface 56 of secondary ratchet 30b (FIGS. 8B to 10B), whereupon secondary ratchet 30b is free to rotate from the secondary striker capture position to the secondary striker releasing position (FIGS. 11A and 11B). Continued rotation of power release gear 28 in the second direction D2 causes second feature 34b to bypass coupling lever 38, whereupon coupling lever 38 automatically returns to its coupling lever rest position under the bias imparted by coupling lever biasing member 38c and pawl 32 automatically returns to its pawl rest position under the bias imparted by pawl biasing member 32a (FIGS. 10A and 10B), whereat latch assembly 10 is brought to its fully open, unlatched state, and ratchet assembly 30 is in its striker release position (FIGS. 11A and 11B).

The aforementioned configuration provides a latch assembly without the need for a return spring, and as a result more output force/reduced gear ratio for faster activation/low power motor/better reliability is achieved. Furthermore, a faster activation from fully closed to fully open position (no need to wait for repositioning cycle by spring by motor activation) is achieved.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A latch assembly for a motor vehicle comprising:
a ratchet assembly having a primary striker capture position, whereat a striker is captured by the ratchet assembly and the latch assembly is in a primary latched state, a secondary striker capture position, whereat the striker is captured by the ratchet assembly and the latch assembly is in a secondary latched state, and a striker releasing position, whereat the striker is releasable from the ratchet assembly and the latch assembly is in a fully unlatched state;
a pawl for holding the ratchet assembly in one of the primary striker capture position and the secondary striker capture position, and for allowing the ratchet assembly to move to the striker releasing position; and
a power release mechanism having a motor and a power release gear, where the motor is operable to rotate the power release gear in a first direction to move the pawl in a first actuation to allow the ratchet assembly to move from the primary striker capture position to the secondary striker capture position, and to rotate the power release gear in a second direction, opposite the first direction, to move the pawl in a second actuation to allow the ratchet assembly to move from the secondary striker capture position to the striker releasing position.

2. The latch assembly of claim 1, wherein the power release gear has a first feature configured to move the pawl while the power release gear is rotating in the first direction, and a second feature configured to move the pawl while the power release gear is rotating in the second direction.

3. The latch assembly of claim 2, wherein the first feature is on a first face of the power release gear and the second feature is on a second face, opposite the first face, of the power release gear.

4. The latch assembly of claim 3, wherein the first feature is configured to directly engage the pawl.

5. The latch assembly of claim 4, wherein the second feature is configured to operably drive the pawl via a coupling lever.

6. The latch assembly of claim 5, wherein the coupling lever has a first leg extending away from a pivot axis for selective engagement with the second feature, and a second leg extending away from the pivot axis for selective engagement with the pawl.

7. The latch assembly of claim 6, wherein the coupling lever has a coupling lever rest position and coupling lever actuated position, wherein a coupling lever biasing member biases the coupling lever toward the coupling lever rest position.

8. The latch assembly of claim 7, wherein the second feature does not engage the first leg during the first actuation, and wherein the second feature engages the first leg during the second actuation to move the coupling lever against the bias of the coupling lever biasing member from the coupling lever rest position to the coupling lever actuated position, whereupon the pawl is driven by the second leg from a pawl rest position to a ratchet releasing position, whereat the ratchet assembly is able move from the secondary striker capture position to the striker releasing position.

9. The latch assembly of claim 8, wherein the second feature disengages the first leg upon completion of the second actuation to allow the coupling lever to return to the coupling lever rest position under the bias of the coupling lever biasing member, whereupon the pawl is returned under a bias of a pawl biasing member from the ratchet releasing position to the pawl rest position.

10. The latch assembly of claim 1, wherein the pawl has a pawl rest position and a ratchet releasing position, the pawl being moved from the pawl rest position to the ratchet releasing position and back to the rest position during the first actuation, and the pawl being moved from the pawl rest position to the ratchet releasing position and back to the rest position during the second actuation.

11. The latch assembly of claim 1, wherein the ratchet assembly includes primary ratchet having a primary striker slot and a secondary ratchet having a secondary striker slot, the primary ratchet supported for rotation about a primary ratchet axis and the secondary ratchet supported for rotation about a secondary ratchet axis spaced from the primary ratchet axis.

12. The latch assembly of claim 11, wherein the primary ratchet captures the striker in the primary striker slot when the latch assembly is in the primary latched state, and the secondary ratchet captures the striker in the secondary striker slot when the latch assembly is in the secondary latched state.

13. The latch assembly of claim 12, wherein the striker is released from the primary striker slot when the latch assembly is in the secondary latched state.

14. The latch assembly of claim 12, wherein the primary striker slot and the secondary striker slot face each other.

15. The latch assembly of claim 1, wherein the power release gear rotates less than 360 degrees in the first direction during the first actuation and rotates less than 360 degrees in the second direction during the second actuation.

16. A latch assembly for a motor vehicle comprising:
a ratchet assembly including a primary ratchet having a primary striker slot and a secondary ratchet having a secondary striker slot, the ratchet assembly having a primary striker capture position, whereat a striker is captured in the primary striker slot of the primary ratchet and the latch assembly is in a primary latched state, a secondary striker capture position, whereat the striker is captured in the secondary striker slot of the secondary ratchet and the latch assembly is in a secondary latched state, and a striker releasing position, whereat the striker is releasable from the secondary striker slot and the latch assembly is in a fully unlatched state;
a pawl for holding the primary ratchet in the primary striker capture position and for holding the secondary ratchet in the secondary striker capture position, and for allowing the ratchet assembly to move to the striker releasing position; and
a power release mechanism having a motor and a power release gear, where the motor is operable to rotate the power release gear in a first direction to move the pawl in a first actuation to allow the primary ratchet to move from the primary striker capture position to a primary striker releasing position, and to rotate the power release gear in a second direction, opposite the first direction, to move the pawl in a second actuation to allow the secondary ratchet to move from the secondary striker capture position to the secondary striker releasing position.

17. The latch assembly of claim 16, wherein the pawl has a pawl rest position and a ratchet releasing position, the pawl being moved from the pawl rest position to the ratchet releasing position and back to the rest position during the first actuation, and the pawl being moved from the pawl rest position to the ratchet releasing position and back to the rest position during the second actuation.

18. The latch assembly of claim 17, wherein a first face of the power release gear has a first feature configured to move the pawl while the power release gear is rotating in the first direction, and a second face of the power release gear, opposite the first face, has a second feature configured to move the pawl while the power release gear is rotating in the second direction.

19. The latch assembly of claim 18, wherein the first feature is configured to directly engage the pawl to move the pawl from the rest position to the ratchet releasing position and then bypass the pawl to allow the pawl to return to the pawl rest position, and the second feature is configured to directly engage a coupling lever to move the coupling lever into engagement with the pawl to move the pawl from the rest position to the ratchet releasing position and then bypass the pawl to allow the pawl to return to the pawl rest position.

20. The latch assembly of claim 19, wherein the coupling lever has a first leg extending away from a pivot axis for engagement with the second feature, and a second leg extending away from the pivot axis for engagement with the pawl, the first leg and the second leg extending in inclined relation with one another.
